(19) United States
(12) Patent Application Publication
(10) Pub. No.: US 2026/0072406 A1
(43) Pub. Date: Mar. 12, 2026

(54) BEARING FOR A HOROLOGY COMPONENT AXIS

(71) Applicant: ETA SA Manufacture Horlogère Suisse, Grenchen (CH)

(72) Inventor: Cyril RUCHTI, Yverdon-les-Bains (CH)

(73) Assignee: ETA SA Manufacture Horlogère Suisse, Grenchen (CH)

(21) Appl. No.: 19/283,694

(22) Filed: Jul. 29, 2025

(30) Foreign Application Priority Data
Sep. 6, 2024 (EP) 24199008.4

(51) Int. Cl. G04B 31/04; G04B 31/08

(52) U.S. Cl. CPC G04B 31/04; G04B 31/08

(57) ABSTRACT

A bearing (1) for an axis of a horology component including a bearing body (2) having an enclosure delimited by a peripheral wall (20) of the bearing forming a through hole (8), the hole (8) including a compact restrained assembly (10) including a first resilient organ (3) and an assembly (27) including a storage space (33) for fluid (31) consisting of a second resilient organ (6), a pivot element (5) and an endstone element (4), the first resilient organ (3) being mounted in a first orifice (9a) of the through hole (8) by being secured in through openings provided in the peripheral wall, the first organ (3) being configured to at least elastically damp axial shocks, and in the assembly (27), in this bearing (1) only the second resilient organ (6) of this assembly (10) is secured to the peripheral wall (20).

### CROSS REFERENCE TO RELATED APPLICATIONS

This application claims priority to European Patent Application No. 24199008.4, filed on Sep. 6, 2024, the entire contents of which are incorporated herein by reference.

### TECHNICAL FIELD OF THE INVENTION

The embodiments of the present invention relate to a bearing for an axis of a horology component, in particular a shock-absorbing bearing for an axis of a horology component. The invention also relates to a horology movement fitted with such a bearing. The invention further relates to a timepiece comprising such a bearing and/or such a horology movement.

### TECHNOLOGICAL BACKGROUND

Among the parts used in horology, the axes of horology components generally have pivots at their ends that rotate in bearings mounted in ebauches, such as plates or bars. For some horology components, in particular balances, it is common practice to fit the bearings with a shock-absorbing mechanism. Indeed, as the axis pivots of these balances are generally thin and the weights of these balances are relatively high, the pivots can break under the effect of a shock if there are no shock-absorbing mechanisms.

In the prior art, a conventional damper bearing commonly comprises a bearing such as a pierced stone with a through hole forming an axial and radial guide element for the pivot. Such a stone is set in a bearing support, commonly known as a setting, in which an endstone is mounted, forming an axial stop for the pivot. This setting is used to transform all or part of a radial shock into an axial shock. Such a setting is maintained against the back of a bearing body by resilient means, generally a spring damper, arranged to exert an axial restraint on the upper part of the endstone. This axis pivot 28 is inserted into the through hole in the pierced stone. Such a bearing absorbs shocks, as the assembly formed by the setting, by the pierced stone and by the endstone can move due to the spring damper.

However, one of the major drawbacks of such a bearing is its lack of robustness, due in particular to the ageing of the lubricant it comprises or to wear over time, which alters its function and makes it less reliable. As a result, such a bearing can no longer guarantee perfect radial recentring of the balance staff in the event of a shock, as this recentring is often random. The problem in this case lies in the fact that the rate of the movement is timed at a given moment T, in a given shock-resistant configuration. After a shock, the bearing configuration changes, for example due to imperfect recentring, and the previous rate setting is no longer optimal. In other words, the position of the balance staff has a direct impact on the rate of the movement, so for greater chronometric stability it is necessary to avoid this recentring defect.

### SUMMARY OF THE INVENTION

One of the purposes of the invention is to provide a small-scale bearing for a timepiece that enables the axis of a horology component to be repositioned extremely effectively at all times, while guaranteeing lubrication in all circumstances.

Another purpose of the invention is to provide a bearing that makes it possible to repeatably position the axis of a horology component.

To this end, the invention relates to a bearing for an axis of a horology component comprising a bearing body comprising an enclosure delimited by a peripheral wall of said bearing forming a through hole, said hole comprising a compact restrained assembly comprising a first resilient organ and an assembly comprising a storage space for fluid consisting of a second resilient organ, of a pivot element and of an endstone element, said first resilient organ being mounted in a first orifice of the through hole by being secured in through openings provided in said peripheral wall, said first organ being configured to at least elastically damp axial shocks, and in said assembly:
the second resilient organ is arranged between the first resilient organ and a second orifice of said hole, said second organ being configured to at least elastically damp radial shocks.
the pivot element is provided to pivot said axis of the horology component, said element being arranged in a central zone of the second resilient organ by being positioned facing the second orifice through which said axis of said component can be inserted into said hole; and
the endstone element is inserted between the first and second resilient organs and is configured to receive an end part of said axis of the component, this endstone element comprising a body made in one piece from a central part and from a peripheral part, the central part comprising a first zone for maintaining this body in the bearing body that is configured to engage with the first resilient organ;
   in this bearing only the second resilient organ of this assembly is secured to said peripheral wall.

In other embodiments:
the central part of the endstone element comprises a cavity arranged facing the pivot element, a section of the cavity having a shape substantially similar to that of the letter M;
the central part of the endstone element comprises a cavity arranged facing the pivot element, said cavity comprising a flat receiving zone for one end of said axis comprised in a central part of this cavity;
the central part of the endstone element comprises a cavity arranged facing the pivot element, said cavity comprising a recess comprising first and second walls, said recess surrounding the receiving zone;
the flat receiving zone is arranged above the pivot element, partially covering its top, in particular a central part of this top;
the recess comprises a first wall arranged above the pivot element, partially covering its top, in particular a peripheral part of this top;
the receiving zone and a first wall of the recess form an acute angle facing a second wall of the recess;
the first and second walls of said recess form an obtuse angle facing the pivot element and the second resilient organ;
the fluid storage space forms an interface of the endstone and pivot elements;
the fluid storage space, in particular for a lubricating fluid, is defined between the top of the pivot element, the receiving zone and the first wall of the recess;
the peripheral part comprises a second zone for maintaining the body of the endstone element in the bearing body, this second maintenance zone being configured so as to bear on the entire periphery of a flat upper face of the second resilient organ;
the second maintenance zone bears only on the periphery of the flat upper face of the second resilient organ under the effect of a force applied by the first resilient element on the first maintenance zone;
the first and second maintenance zones and the receiving zone are comprised, respectively, in separate planes which are parallel to each other;
the central part and the peripheral part respectively form a top and a base of the endstone element;
the endstone element is mounted so as to be axially mobile in the through hole relative to an axis of revolution of this hole;
the central part of the endstone element is configured to be introduced into the first orifice of the through hole if the horology component is subjected to a shock;
the peripheral part of the endstone element comprises a clearance zone configured to engage the first resilient organ if the horology component is subjected to a shock;
the part of the pivot element arranged in the cavity protrudes from the central zone of the second resilient organ, this part comprising an outer surface that is positioned in the vicinity of the receiving zone and of a first wall of the cavity;
the first resilient organ is configured to distort essentially axially relative to an axis of revolution of the through hole;
the first resilient organ comprises elements for securing this organ in the through hole and restraining elements intended to bear on the first maintenance zone of the central part of the endstone element and connecting elements joining the restraining elements and the securing elements;
the second resilient organ comprises a part for connecting said organ in the through hole and a part for securing the pivot element in a central zone of said organ, said connecting and securing parts being joined by at least one resilient element of said organ;
the second resilient organ is fixedly mounted in the bearing body;
the second resilient organ is configured to distort essentially radially relative to an axis of revolution of the through hole;
the bearing body, the through hole, the first and second resilient organs, the endstone element and the pivot element have axes of revolution that are coincident with a central axis of the bearing;
the endstone element is made of a transparent or translucent material;
the receiving zone is flat and polished.

Another aspect of the invention relates to a horology movement fitted with such a bearing.

Another aspect of the invention relates to a timepiece comprising such a horology movement.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 is a perspective view of a bearing for an axis of a horology component, according to an embodiment of the invention;

FIG. 2 is a top view of the bearing shown in FIG. 1, according to the embodiment of the invention;

FIG. 3 is a cross-sectional view along an axis III-III of the bearing shown in FIG. 2, according to the embodiment of the invention; and

FIG. 4 is an exploded view of all of the parts forming the bearing, according to the embodiment of the invention.

### DETAILED DESCRIPTION OF THE INVENTION

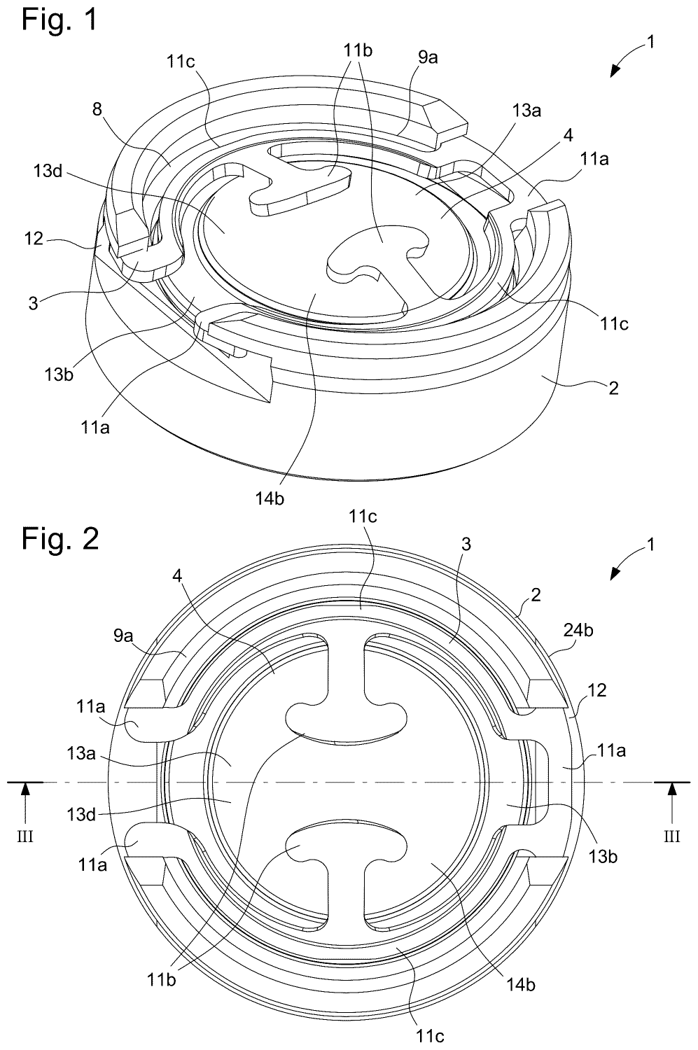

FIGS. 1 to 4 illustrate an embodiment of a bearing 1 for an axis of a horology component. Such a horology component and this bearing 1 can be part of a horology mechanism in a horology movement such as an electromechanical movement or a mechanical movement. This movement is comprised in a timepiece such as a watch, in particular a wristwatch. It should be noted that the horology mechanism can be a sprung balance oscillator with a balance and a spring.

This bearing 1, also referred to as a “horology bearing,” “shock-absorber bearing” or “damper bearing,” is particularly suitable for pivoting an axis, in particular an axis pivot 32, and also for ensuring the lubrication of this axis pivot 32. This axis pivot 32 is an end 32 of this axis or an end part 32 of such an axis. Such an axis 28 is preferably made of metal, ceramic or glass. This axis, also referred to as a “rotary axis,” “pivot axis” or “arbor” can be the axis of a horology component, also referred to as a “rotary mobile axis” such as a pivot shank on a balance when the horology mechanism is an oscillator.

Such a bearing 1 is effectively configured to:
guide the rotation of the axis of the horology component; and/or
stop the axis in translation; and/or
ensure the lubrication of this axis and in particular of the part of this axis that is arranged in the bearing 1.

It should be noted that such rotational guidance of this axis is achieved around the central axis A1 of this bearing 1, otherwise known as the axis A1 of the mounted bearing. In particular, such a bearing 1 helps limit axial and/or radial translational movements relative to the axis A1 of this axis of the horology component.

It is understood that the guidance of the axis 28 of this horology component is linked to the movements of this component relative to the axis A1. In this context, these movements are limited in axial and/or radial translation due to this bearing 1.

Such a bearing 1 is designed to be assembled or attached to an ebauche of the horology movement such as a bar, for example a balance cock, or a plate. Alternatively, the bearing 1 can be formed directly in the body of a plate or of a bar, for example by machining.

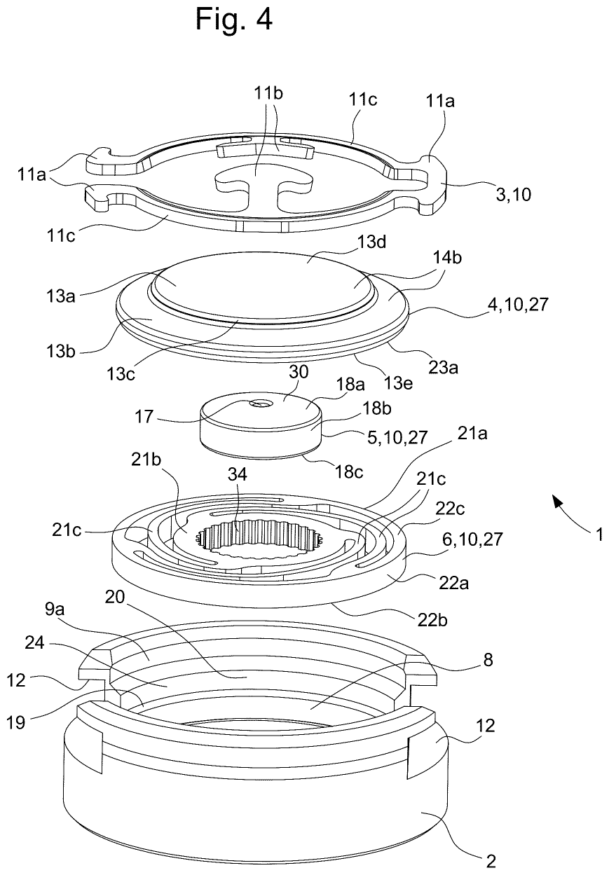

Referring to FIG. 4, the bearing 1 comprises a bearing body 2 that is configured to receive a compact assembly 10 comprising the following components: a first resilient organ 3 and an assembly 27 comprising a fluid storage space 33 or a fluid reservoir, in particular a fluid 31 such as a lubricating fluid. This assembly 27 comprises a second resilient organ 6, a pivot element 5 and an endstone element 4. In this assembly 27, this storage space 33 forms an interface or junction between the endstone element 4 and the pivot element 5. In other words, this storage space 33 for fluid 31 forms an interface between a receiving zone 25 on the axis pivot 32 of the endstone element 4 and the top 30 of the pivot element 5. It should be noted that this storage space 33 is defined by the presence of the fluid 31 that is confined in this space 33. It is thus understood that this storage space 33 or the fluid 31 stored therein, forms this interface or a single interface of the endstone element 4 and the pivot element 5 in this bearing 1.

In other words, the fluid 31 comprised in this storage space 33, forms this interface or the single interface of the endstone element 4 and the pivot element 5. More specifically, this fluid comprised in this storage space 33:
is or defines or constitutes a common boundary between the endstone element 4 and the pivot element 5; or
is or defines or constitutes the common boundary between the receiving zone 25 of the axis pivot 32 of the endstone element 4 and the top 30 of the pivot element 5; or
is or defines or constitutes the common boundary between the receiving zone 25 and the first wall 29a of the recess 26 and the top 30 of the pivot element 5; or
is or defines or constitutes a surface separating the two endstone elements 4 and pivot 5; or
is or defines or constitutes the surface separating the receiving zone 25 from the axis pivot 32 of the endstone element 4, and the top 30 of the pivot element 5; or
is or defines or constitutes the surface separating the receiving zone 25 and the first wall 29a of the recess 26 and the top 30 of the pivot element 5.

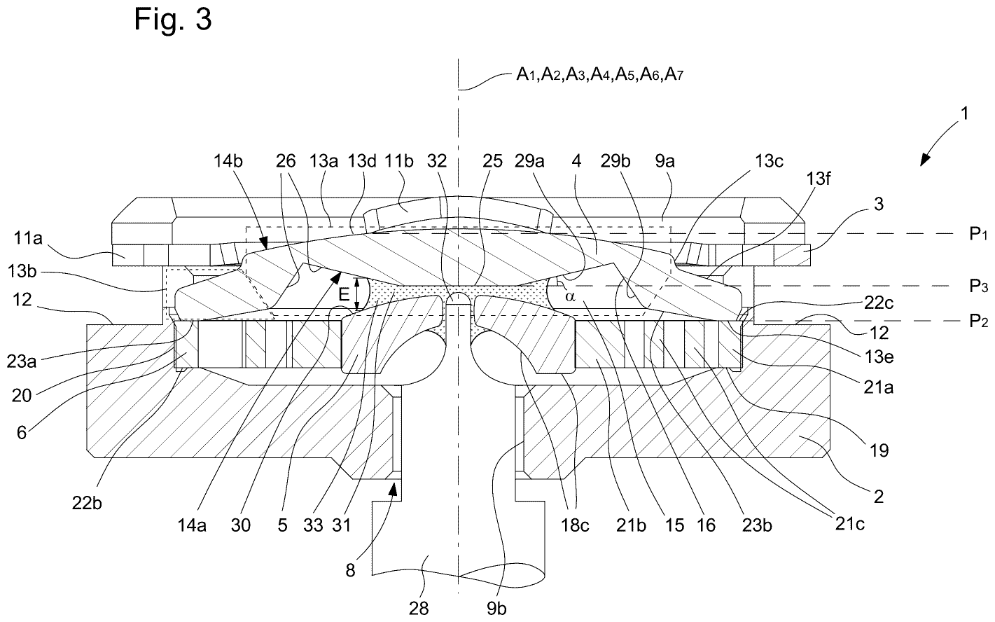

This bearing body 2 comprises an enclosure in which this assembly is arranged. Such an enclosure is delimited by a peripheral wall 20 of this bearing so as to form a through hole 8. Referring to FIG. 3, such a through hole 8, also referred to as a “central through hole,” extends in a direction parallel to that of an axis of revolution A2 of this bearing body 2, also referred to as a block axis.

Such a through hole 8 comprises first and second orifices 9a, 9b at each end. It should be noted that the cross-section of the first orifice 9a is preferably greater than the cross-section of the second orifice 9b. As will be seen below, the first orifice 9a is configured to participate in mounting the first resilient organ 3 in the through hole 8 and the second orifice 9b is configured to enable the axis of the horology component to be introduced into this same hole 8.

In this bearing body 2, the through hole 8 comprises an axis of revolution A3, also known as the axis of the hole 8, which is coincident with the central axis A1 of the bearing 1. Such a through hole 8 has a geometry of revolution around this axis A3 that forms the enclosure of this bearing body 2. It should be noted that this enclosure corresponds to the volume defined in the bearing body 2 by the peripheral wall 20 of this through hole 8 as seen in FIG. 4. In this configuration, such an enclosure therefore extends between the first and second orifices 9a, 9b that form part of such a bed.

In this bearing 1, the through hole 8 is configured to receive or participate in the arrangement, or in the mounting, of the compact assembly 10 in the bearing body 2. In this configuration, the compact assembly 10 comprises mounting zones 11a, 21a, 22a, 22b intended to engage with an inner surface 24 of the peripheral wall 20 of the through hole 8 in order to ensure the arrangement of this compact assembly 10 in the bearing body 2. Such mounting zones 11a, 21a, 22a, 22b are comprised in/on the first and second resilient organs 3, 6 of this assembly 10. In one variant, these mounting zones 11a, 21a, 22a, 22b are exclusively comprised in/on the first and second resilient organs 3, 6. In other words, these mounting zones 11a, 21a, 22a, 22b are the only parts of this compact assembly 10 that carry out/ensure its mounting in the bearing body 2 to form the bearing 1. As will be seen below, these mounting zones 11a, 21a, 22a, 22b engage with this bearing body 2 by bearing on and/or being secured to this body 2.

In this assembly, the pivot element 5, the endstone element 4, the first resilient organ 3 and the second resilient organ 6 respectively comprise central axes A4, A5, A6, A7. These axes referenced A4, A5, A6, A7 are coincident with the axes A1, A2, A3 respectively of the bearing 1, of the bearing body 2 and of the through hole 8 when the compact assembly 10 is mounted in the bearing body 2.

Thus, as mentioned above, this compact assembly 10 consists of the first resilient organ 3 and the assembly 27 comprising this storage space 33 for fluid 31.

The first resilient organ 3, which is, for example, a resilient element such as a return spring, is designed to elastically return the endstone element 4 and adequately reposition the axis of the horology component axially within the hole 8 of the bearing body 2 after a substantially axial shock sustained by the timepiece, in particular sustained by the horology movement of this timepiece. In other words, the first resilient organ 3 is configured to distort essentially axially relative to the axis of revolution A3 of the through hole 8. More specifically, this first organ 3 is configured to axially reposition the axis of the horology component invariably at the same point, being designed so as to absorb substantially axial shocks. It is therefore understood that this organ 3 is configured to axially position the axis of the horology component in its initial or resting position relative to the axis of revolution referenced A3 in response to these shocks.

A first such resilient organ 3 is attached or secured to the bearing body 2. More specifically, this first resilient organ 3 is mounted in the first orifice 9a of the through hole 8. To do so, this first resilient organ 3 comprises at least one connecting element 11c, at least one restraining element 11b and at least one securing element 11a that are joined.

More specifically, this organ 3 comprises securing elements 11a, also known as “attachment elements,” which are configured so as to be arranged in openings 12 formed in the part of the peripheral wall 20 located in this first orifice 9a of the hole 8. Referring to FIG. 4, this first organ 3 comprises two securing elements 11a. Each securing element 11a is configured to be arranged in the corresponding opening 12 of said peripheral wall 20 in order to participate in the mounting of said first resilient organ 3 in said hole 8. It should be noted that these securing elements 11a are part of the aforementioned mounting zones 11a, 21a, 22a, 22b of the assembly 10 in the bearing body 2.

The first resilient organ 3 also comprises restraining elements 11b that are in contact with the endstone element 4 of the assembly 27. More specifically, the restraining elements 11b are intended to bear on a first maintenance zone comprised on an outer face 14b of a central part 13a of the endstone element 4, in particular on a top 13d of this endstone element 4. These restraining elements 11b are configured to apply an essentially axial return force, in particular an axial and elastic force, to this endstone element 4. Referring to FIG. 4, this first resilient organ 3 preferably comprises two restraining elements 11b.

The first resilient organ 3 also comprises connecting elements 11c joining the restraining elements 11b and the securing elements 11a. In this first resilient organ 3, there are two of these connecting elements 11c, as can be seen in FIG. 4. These connecting elements 11c define a space in which the top 13d of the endstone element 4 can be arranged.

In the assembly 27 of this compact assembly 10, the endstone element 4 is designed to receive the axis pivot 32 (or the end 32 of the axis 28 of the corresponding horology component at the end of the pivot, or to constitute a stop for the end part 32 of this axis 28. In the through hole 8, the endstone element 4 is inserted between the first and second resilient organs 3, 6. Such an endstone element 4 is mounted so as to be axially and radially mobile in such a through hole 8 relative to the axis of revolution A3 of this hole 8.

This endstone element 4 comprises a monobloc body, preferably transparent or translucent. This body consists of the central part 13a and of a peripheral part 13b as well as inner and outer faces 14a, 14b. It should be noted that in this element 4, the central part 13a is surrounded by the peripheral part 13b. Such an endstone element 4 comprises an unhooking zone 13c that joins the central and peripheral parts 13a, 13b and which can be seen on the outer surface 14b of this element 4 as illustrated in FIGS. 3 and 4. In this configuration, such central and peripheral parts 13a, 13b respectively comprise the top 13d and a base 13b of the endstone element 4.

In the inner face 14a of this endstone element 4, the central part 13a comprises a cavity 15 facing the pivot element 5, seen in FIG. 3. It should be noted that such a cavity 15 can be produced by machining, in particular by conventional machining with a diamond tool or by laser machining. As will be seen later, this cavity 15 is configured to receive/accommodate part of the pivot element 5. Such a cavity 15 has a cross-sectional shape substantially similar to that of the letter M.

More specifically, such a cavity 15 comprises:
a receiving zone 25 for the axis pivot 32 comprised in a back 16 of this cavity 15; and/or
said receiving zone 25 being comprised in a portion of the inner face 14a located in the central part 13a of the endstone element 4; and/or
said receiving zone 25 being flat; and/or
said receiving zone 25 preferably being polished; and/or
said receiving zone 25 preferably being perpendicular to the axes A1, A2, A3, A4, A5, A6, A7, or perpendicular to the pivot axis; and/or
said receiving zone 25 being located in a central zone of the portion of the inner face 14a located in the central part 13a; and/or
a recess 26 surrounding this receiving zone 25; and/or
said recess 26 extending into the portion of the inner face 14a located in the central part 13a around the receiving zone 25.

This receiving zone 25 and the recess 26 form a back 16 in relief in this cavity 15. More specifically, this recess 26 consists of two inner walls 29a, 29b. These first and second walls 29a, 29b are contiguous and together form a preferably obtuse angle. This angle is arranged facing the pivot element 5 and the second resilient organ 6.

In this configuration, the first wall 29a forms, with the receiving zone 25, an acute angle α that is comprised between 0 and 45 degrees and is preferably 25 degrees. This angle α is arranged facing the second wall 29b.

In this assembly 27, the receiving zone 25 is arranged above the pivot element 5, partially covering its top 30, in particular a central part of this top 30 that comprises a central hole 17 of this pivot element 5. It should be noted that all of this zone 25 covers the central part of this top 30. The first wall 29a itself is arranged above this pivot element 5, partially covering its top 30, in particular the peripheral part of this top 30.

In this configuration, it should be noted that the fluid 31 flows from the storage space 33 into this central hole 17 in order to maintain continuous/permanent/constant lubrication of the axis pivot 32 positioned in this through hole 17. Preferably, this hole 17 is the only zone for the flow, evacuation or transmission of fluid from this storage space 33.

Furthermore, in such an assembly 27, the top 30 of the pivot element 5, the receiving zone 25 and the first wall 29a of the recess 26 are configured to define the storage space 33 for the lubricating fluid 31. More specifically, the arrangement of this top 30, of the receiving zone 25 and of the first wall 29a relative to each other helps ensure that the lubricating fluid 31 is kept in this space from the combination:
of a physico-chemical phenomenon called surface tension of this lubricating fluid 31 that is linked to the molecular interactions of the latter; with
an interaction phenomenon occurring at the interfaces between the fluid 31 and the surfaces in contact with this fluid at the top 30 of the pivot element 5, in the receiving zone 25 and in the first wall 29a of the recess 26, respectively.

It is therefore understood that the configuration of these respective surfaces of the top 30 of the pivot element 5, of the receiving zone 25 and of the first wall 29a of the recess 26 between them enables these surfaces to interact jointly with this fluid 31 to generate such phenomena which thus help contain this fluid 31 in this storage space 33. More specifically, the direction of these surfaces relative to each other and the gap E defined between the surface of the top 30 and the portion of the inner face 14a consisting of the receiving zone 25 and of the first wall 29a, enable these surfaces to interact jointly with this fluid 31 to generate such phenomena. In particular, it should be noted that this separation E increases from the central hole 17 of the pivot element 5 towards its periphery. In other words, this separation E increases with the radial movement away from the axis A4 of the pivot element 5 that runs through the central hole 17 of this element 5 towards its periphery.

This fluid 31 thus kept in this storage space 33, helps ensure continuous/permanent/constant lubrication of the axis pivot 32 positioned in this assembly 27. Moreover, it should be noted that such a storage space 33 is capable of containing this fluid 31 even during a variation in the volume of this space that may result from the displacement of the axis in the assembly 27 when the timepiece has been subjected to a shock.

As mentioned previously, the central part referenced 13a comprises the top 13d and the cavity 15 respectively comprised in the outer face 14b and the inner face 14a of the endstone element 4. This top 13d is configured/conformed so as to be introduced into the first resilient organ 3, in particular into the space defined in this organ, which is delimited by the connecting elements 11c of this first resilient organ 3, in particular during a substantially axial shock that may be sustained by the timepiece.

The peripheral part 13b comprises a support base 13e and a clearance zone 13f respectively comprised in the inner face 14a and the outer face 14b of the endstone element 4. The support base 13e comprises a second zone 23a for maintaining the endstone element 4. This maintenance zone 23a is configured to bear directly on the periphery of a flat upper face of the second resilient organ 6. In the inner face 14a, this maintenance zone 23a is joined by a connecting part 23b to the second wall 29b of the recess 26. This connecting part 23b forms an acute angle with the maintenance zone 23a, arranged facing the pivot element 5 and the second resilient organ 6.

Such a connecting part 23b also forms with the second wall 29b an obtuse angle arranged facing the pivot element 5 and the second resilient organ 6.

In one variant, the second maintenance zone 23a is configured to bear directly on the entire periphery of the flat upper face of the second resilient organ 6. This second maintenance zone 23a is preferably flat. In this configuration, the second maintenance zone 23a bears solely on this periphery of the flat upper face of the second resilient organ 6 under the effect of the force, in particular the axial force, applied by the first resilient element 3 to the first maintenance zone of the endstone element.

The clearance zone 13f is configured to engage with the first resilient organ 3 if the timepiece sustains a shock. Indeed, such a clearance zone 13f is more specifically defined on a portion of the outer face 14b of the endstone element 4 located in this peripheral part 13b. In this configuration, this clearance zone 13f can engage with the connecting elements 11c and the securing elements 11a in order to limit the axial displacement of the axis of the horology component in the event of a shock, particularly a strong, substantially axial shock.

Such an endstone element 4 can be, for example, an endstone made of a precious stone, synthetic or otherwise, of mono-or polycrystalline material, such as ruby or zirconia, an element made of metal or of silicon-based material (such as mono-or polycrystalline silicon, its oxide, its nitride or its carbide, also mono-or polycrystalline). The body of this endstone element 4 when it is a mineral has a hardness greater than or equal to 7, and preferably greater than or equal to 9 on the Mohs hardness scale. If this endstone element 4 is metallic, its hardness measured in Vickers hardness is comprised between 150 HV and 450 HV and preferably between 200 HV and 390 HV.

It should be noted that the endstone 4 is preferably transparent or translucent, in particular to allow easy control of the amount of lubricating fluid 31 present in the reservoir-forming assembly 27, through the first orifice 9a of the bearing 1.

Referring to FIG. 3, it should be noted that in this endstone element 4, the first and second maintenance zones and the receiving zone 25 are comprised between separate planes P1, P2, P3 which are parallel or substantially parallel to each other. Such planes P1, P2, P3 are perpendicular or substantially perpendicular to the axes A1, A2 A3, A4, A5, A6, A7.

In this assembly 27, the pivot element 5 is designed to pivot the axis of the horology component. This pivot element 5 comprises a central hole 17 for receiving this axis of the horology component and in particular the end part 32 of this axis. This pivot element 5 is detachably arranged in a central zone of the second resilient organ 6 by being positioned facing the second orifice 9b by which the axis of the horology component can be introduced into said through hole 8. Such a pivot element 5 comprises upper 18a, lateral 18b and lower 18c surfaces, with the lateral surface 18b joining these upper and inner surfaces 18a, 18c. In this configuration, the upper surface 18a of this element 5 is arranged facing the inner face 14a of the endstone element 4 and the lower surface 18c facing the second orifice 9b. More specifically, this pivot element 5 comprises a part protruding from the second resilient organ 6 that is arranged in the cavity 15 of the endstone element 4 with the upper surface 18a that is positioned in the vicinity of the receiving zone 25 of this cavity 15.

Such a pivot element 5, also known as a “bearing,” can be a pierced stone, conventionally made of a synthetic precious stone or of a material that is not mono-or polycrystalline, such as ruby or zirconia, or a silicon-based material (such as mono-or polycrystalline silicon, its oxide, its nitride or its carbide, also mono-or polycrystalline) or a ring made from a metallic material.

In this assembly 27, the second resilient organ 6 is arranged/fixedly mounted in the through hole 8 and therefore in the bearing body 2. In this through hole 8, this second resilient organ 6 is arranged on a shoulder 19 included on the peripheral wall 20 of this hole 8. It should be noted that this shoulder 19 is located at the back of the orifice 9a and is orthogonal to the surface of the peripheral wall 20. Moreover, such a shoulder 19 ensures correct mounting of this second resilient organ 6 in the bearing body 2 and alignment of the central axis A7 of this second organ 6 with the axis A1 of this bearing 2. In this assembly 10, the second resilient organ 6 is configured to distort essentially radially relative to the axis of revolution A3 of the through hole 8. In other words, this second organ 6 is configured to radially recentre the axis of the horology component invariably at the same point and is designed to absorb radial shocks.

More specifically, this second resilient organ 6 comprises the part for connecting 21a to the peripheral wall 20 of the through hole 8, and a part for securing 21b the pivot element 5 in a central zone of said organ 6, said connecting and securing parts 21a, 21b being joined by at least one resilient element 21c of said organ 6. It should be noted that the connecting and securing parts 21a, 21b are rigid parts of this organ 6 in comparison with the resilient element 21c. These connecting and securing parts 21a, 21b are capable of distorting elastically when restrained.

Said at least one resilient element 21c is configured to ensure the radial distortion of the second resilient organ 6 by controlling the displacement of the securing part 21b relative to the connecting part 21a when the movement is subjected to shocks. In other words, the elastic element 21c is configured to place, radially relative to the A3 referenced axis of revolution, the connecting part 21a or the pivot element 5 or the axis of the clock component in its initial or resting position in response to shocks.

This second resilient organ 6 also comprises flat upper and lower faces that are preferably substantially parallel to each other.

The connecting part 21a forms an outer peripheral wall of this second resilient organ 6. In this configuration, when the second resilient organ 6 is mounted in the through hole 8, a lateral surface 22a of this outer peripheral wall, and therefore of this connecting part 21a, bears on all or part of the peripheral wall 20 of this hole 8. In fact, this connecting part 21a is configured to elastically distort when the second resilient organ 6 is inserted into the through hole 8. Thus, this connecting part 21a is then able to bear on the peripheral wall 20 of the hole 8 from its lateral surface 22a. By way of example, the second resilient organ 6 can be inserted by driving in this through hole 8.

This connecting part 21a also comprises a contact surface 22b that is configured to engage with the shoulder 19 comprised in the through hole 8. Referring to the above example, it should be noted that the second resilient organ 6 is inserted by driving in the through hole 8 until it stops against the shoulder 19 of the through hole 8 via the contact surface 22b of the connecting part 21a. It should be noted that this contact surface 22b is comprised on the flat lower face of this second organ 6.

It is therefore understood that such a connecting part 21a enables the second fixed resilient organ 6 to be fitted/mounted in the through hole 8. In other words, this connecting part 21a helps secure or maintain the second resilient organ 6 that is sufficiently strong (e) to avoid any relative axial, radial and/or angular displacement of this second organ 6 relative to the axis of revolution A3 of the hole 8.

It should be noted that this connecting part 21a is part of the mounting zones 11a, 21a, 22a, 22b of the compact assembly 10 in the bearing body 2. In other words, the contact surface 22b and the lateral surface 22a of this connecting part 21a are comprised in these mounting zones 11a, 21a, 22a, 22b.

The connecting part 21a also comprises a support surface 22c forming/comprising the periphery of the flat upper face which is configured to engage with the second maintenance zone 23a of the endstone element 4. In fact, the base 13b of the endstone element 4 is designed to bear directly on this support surface 22c. In the connecting part 21a, this support surface 22c is positioned above or plumb with the contact surface 22b. This support surface 22c is also substantially parallel to the contact surface 22b.

As previously mentioned, the second resilient organ 6 also comprises a securing part 21b for the pivot element 5 in the central zone of this second organ 6. This securing part 21b comprises an inner peripheral wall 34 of this second resilient organ 6. The pivot element 5 can be a part attached to this second organ 6 with its lateral surface 18b configured to be completely or partially attached to this inner peripheral wall 34. Such a connection can be made by driving in, gluing or soldering. It should be noted that the surface of this inner peripheral wall 34 comprises protuberances/reliefs that participate in the securing of the pivot element 5 in the central zone of this second organ 6.

It should be noted that in one variant, this pivot element 5 can be an integral part of this second organ 6 by being made of the same material as the securing part 21b. In this configuration, the central zone of this second organ 6 is then considered to consist of this pivot element 5.

This second resilient organ 6 can be produced by microfabrication, using a deep reactive ion engraving method (usually known by its acronym “DRIE”) for an organ 6 comprising, in particular, silicon, or using a LIGA method such as UV-LIGA for a nickel-based organ 6, for example.

Such a bearing 1 according to the invention therefore has a small/reduced scale compared with bearings in the prior art, without affecting the function of this bearing 1. This smaller scale is achieved in particular by the compact assembly 10 formed by the first and second resilient organs 3, 6 and the endstone and pivot elements 4, 5, and more specifically by:
the particular shape of the endstone element 4 that enables the central part 13a of this element 4, in this case the top 13d, to move in the first orifice 9a of the through hole 8 in the bearing body 2;
the particular shape of the endstone element 4, which enables its base 13b to bear directly on the flat upper face of the second resilient organ 6 plumb with the shoulder 19;
the presence of a cavity 15 in the inner face 14a of the endstone element 4, in which a part of the pivot element 5 can be arranged;
the particular shape of the recess 26 configured to guarantee a correct amount of lubrication in all operating/shock conditions of the movement;
the positioning the pivot element 5 in a central zone of the second resilient organ 6, with a part of the body of this element 5 being comprised in the thickness of this second resilient organ 6.

It should be noted that in this bearing 1, the endstone element 4, by bearing on the upper face of the second resilient organ 6, exerts only an axial and elastic force on the entire periphery of the flat upper face of this second resilient organ 6 under the action of the restraining elements 11b bearing on the top 13d of the endstone element 4. This force is then applied by the maintenance zone 23a of the endstone element 4 to the support surface 22c forming said periphery, plumb with the shoulder 19 of the through hole 8. In this context, it is to be understood that the endstone element 4 does not bear on the peripheral wall 20.

It should also be noted that a “substantially axial” shock is a shock that is “strictly axial” or “essentially axial” or “partially axial.” Similarly, a “substantially radial shock” is to be understood as being a shock that is “strictly radial” or “essentially radial” or “partially radial.”

Moreover, in this description, “substantially parallel” means “strictly parallel or essentially parallel.”

A bearing 1 of this type thus help ensure axial and radial recentring/repositioning of the axis of a horology component in its resting position after a shock or acceleration to which the timepiece is subjected, without adversely affecting the lubrication of the pivot of said axis.

1. A bearing (1) for an axis of a horology component comprising a bearing body (2) comprising an enclosure delimited by a peripheral wall (20) of said bearing forming a through hole (8), said hole (8) comprising a compact restrained assembly (10) comprising a first resilient organ (3) and an assembly (27) comprising a storage space (33) for fluid (31) consisting of a second resilient organ (6), of a pivot element (5) and of an endstone element (4), said first resilient organ (3) being mounted in a first orifice (9a) of the through hole (8) by being secured in through openings provided in said peripheral wall, said first organ (3) being configured to at least elastically damp axial shocks, and in said assembly (27):
the second resilient organ (6) is arranged between the first resilient organ (3) and a second orifice (9b) of said hole (8), said second organ (6) being configured to at least elastically damp radial shocks;
the pivot element (5) is configured to pivot said axis of the horology component, said element (5) being arranged in a central zone of the second resilient organ (6) by being positioned facing the second orifice (9b) through which said axis of said component can be inserted into said hole (8); and
the endstone element (4) is inserted between the first and second resilient organs (3, 6) and is configured to receive an end part (32) of said axis of the component, this endstone element (4) comprising a body made in one piece from a central part (13a) and a peripheral part (13b), the central part (13a) comprising a first zone for maintaining this body in the bearing body (2) that is configured to engage with the first resilient organ (3);
in this bearing only the second resilient organ (6) of this assembly (10) is secured to said peripheral wall (20).

2. The bearing (1) according to claim 1, wherein the central part (13a) of the endstone element (4) comprises a cavity (15) arranged facing the pivot element (5), a section of the cavity (15) having a shape substantially similar to that of the letter M.

3. The bearing (1) according to claim 1, wherein the central part (13a) of the endstone (4) comprises a cavity (15) arranged facing the pivot element (5), said cavity (15) comprising:
a flat receiving zone (25) for one end (32) of said axis (28) comprised in a central part (13a) of this cavity (15); and
a recess (26) comprising first and second walls (29a, 29b), said recess (26) surrounding the receiving zone (25).

4. The bearing (1) according to claim 1, wherein the central part (13a) of the endstone (4) comprises a cavity (15) arranged facing the pivot element (5), said cavity (15) comprising:
a flat receiving zone (25) for one end (32) of said axis (28) comprised in a central part (13a) of this cavity (15), the flat receiving zone (25) being arranged above the pivot element (5), partially covering its top (30), in particular a central part of this top (30), and
a recess (26) comprising first and second walls (29a, 29b), said recess (26) surrounding the receiving zone (25).

5. The bearing (1) according to claim 1, wherein the central part (13a) of the endstone (4) comprises a cavity (15) arranged facing the pivot element (5), said cavity (15) comprising:
a flat receiving zone (25) for one end (32) of said axis (28) comprised in a central part (13a) of this cavity (15); and
a recess (26) comprising first and second walls (29a, 29b), said recess (26) surrounding the receiving zone (25), the recess (26) comprising a first wall (29a) arranged above the pivot element (5) partially covering its top (30), in particular a peripheral part of this top (30).

6. The bearing (1) according to claim 1, wherein the central part (13a) of the endstone (4) comprises a cavity (15) arranged facing the pivot element (5), said cavity (15) comprising:
a flat receiving zone (25) for one end (32) of said axis (28) comprised in a central part (13a) of this cavity (15); and
a recess (26) comprising first and second walls (29a, 29b), said recess (26) surrounding the receiving zone (25), the receiving zone (25) and the first wall (29a) of the recess (26) form an acute angle (α) arranged facing the second wall (29b) of this recess (26).

7. The bearing (1) according to claim 1, wherein the central part (13a) of the endstone (4) comprises a cavity (15) arranged facing the pivot element (5), said cavity (15) comprising:
a flat receiving zone (25) for one end (32) of said axis (28) comprised in a central part (13a) of this cavity (15); and
a recess (26) comprising first and second walls (29a, 29b), said recess (26) surrounding the receiving zone (25), the first and second walls (29a, 29b) of said recess (26) form an obtuse angle arranged facing the pivot element (5) and the second resilient organ (6).

8. The bearing (1) according to claim 1, wherein the storage space (33) for fluid (31) forms an interface of the endstone elements (4) and of the pivot (5) element.

9. The bearing (1) according to claim 1, wherein the central part (13a) of the endstone (4) comprises a cavity (15) arranged facing the pivot element (5), said cavity (15) comprising:
a flat receiving zone (25) for one end (32) of said axis (28) comprised in a central part (13a) of this cavity (15);
a recess (26) comprising first and second walls (29a, 29b), said recess (26) surrounding the receiving zone (25), and
the bearing comprising the storage space (33) for fluid (31), in particular a lubricating fluid, being defined between the top (30) of the pivot element (5), the receiving zone (25) and the first wall (29a) of the recess (26).

10. The bearing (1) according to claim 1, wherein the peripheral part (13b) comprises a second zone (23a) for maintaining the body of the endstone element (4) in the bearing body (2), this second maintenance zone (23a) being configured so as to bear on the entire periphery of a flat upper face of the second resilient organ (6).

11. The bearing (1) according to claim 1, wherein the peripheral part (13b) comprises a second zone (23a) for maintaining the body of the endstone element (4) in the bearing body (2), this second maintenance zone (23a) being configured so as to bear on the entire periphery of a flat upper face of the second resilient organ (6), the second maintenance zone (23a) bearing only on the periphery of the flat upper face of the second resilient organ (6) under the effect of a force applied by the first resilient element (3) on the first maintenance zone.

12. The bearing (1) according to claim 1, wherein the peripheral part (13b) comprises a second zone (23a) for maintaining the body of the endstone element (4) in the bearing body (2), this second maintenance zone (23a) being configured so as to bear on the entire periphery of a flat upper face of the second resilient organ (6), the first and second maintenance zones as well as the receiving zone (25) are respectively comprised in separate planes (P1, P2, P3) that are parallel to each other.

13. The bearing (1) according to claim 1, wherein the central part (13a) and the peripheral part (13b) respectively form a top (13d) and a base (13b) of the endstone element (4).

14. The bearing (1) according to claim 1, wherein the endstone element (4) is mounted so as to be axially mobile in the through hole (8) relative to an axis of revolution (A3) of this hole (8).

15. The bearing (1) according to claim 1, wherein the central part (13a) of the endstone element (4) is configured to be inserted into the first orifice (9a) of the through hole (8) if the horology component is subjected to a shock.

16. The bearing (1) according to claim 1, wherein the peripheral part (13b) of the endstone element (4) comprises a clearance zone (13f) configured to engage with the first resilient organ (3) if the horology component is subjected to a shock.

17. The bearing (1) according to claim 1, wherein the part of the pivot element (5) arranged in the cavity (15) protrudes from the central zone of the second resilient organ (6), this part comprising an outer surface (18a) that is positioned in the vicinity of the receiving zone (25) and of a first wall (29a) of the cavity (15).

18. The bearing (1) according to claim 1, wherein the first resilient organ (3) is configured to distort essentially axially relative to an axis of revolution (A3) of the through hole (8).

19. The bearing (1) according to claim 1, wherein the first resilient organ (3) comprises elements (11a) for securing this organ (3) in the through hole (8) and restraining elements (11b) for bearing on the first zone maintaining the central part (13a) of the endstone element (4) and of the connecting elements (11c) joining the restraining elements (11b) and the securing elements (11a) to each other.

20. The bearing (1) according to claim 1, wherein the second resilient organ (6) comprises a connecting part (21a) of said organ (6) in the through hole (8) and a securing part (21b) of the pivot element (5) in a central zone of said organ (6), said connecting and securing parts (21a, 21b) being joined to each other by at least one resilient element (21c) of said organ (6).

21. The bearing (1) according to claim 1, wherein the second resilient organ (6) is fixedly mounted in the bearing body (2).

22. The bearing (1) according to claim 1, wherein the second resilient organ (6) is configured to distort essentially radially relative to an axis of revolution (A3) of the through hole (8).

23. The bearing (1) according to claim 1, wherein the bearing body (2), the through hole (8), the first and second resilient organs (3, 6), the endstone element (5) and the pivot element have axes of revolution (A2, A3, A4, A5, A6, A7) that are coincident with a central axis (A1) of the bearing (1).

24. The bearing (1) according to claim 1, wherein the endstone element (4) is made of a transparent or translucent material.

25. The bearing (1) according to claim 1, wherein the receiving zone (25) is flat and polished.

26. A horology movement provided with the bearing (1) for an axis of a horology component according to claim 1.

27. A timepiece comprising a horology movement provided with the bearing (1) for an axis of a horology component according to claim 1.
